(19) United States
(12) Patent Application Publication
(10) Pub. No.: US 2004/0129039 A1
(43) Pub. Date: Jul. 8, 2004

(54) Security container system and a method of transporting or shipping at least one item

(76) Inventors: Robert E. Reetz, Ridgewood, NJ (US); Chris W. Connors, Port Washington, NY (US); Thomas F. Sullivan, Queens, NY (US)

Correspondence Address: Finnegan, Henderson, Farabow,, Garrett & Dunner, L.L.P., 1300 I Street, N.W., Washington, DC, 20005-3315, US

(21) Appl. No.: 10/336,292

(22) Filed: Jan. 3, 2003

(51) Int. Cl. E05G 1/00; E05B 65/52

(52) U.S. Cl. 70/63; 109/45

(57) ABSTRACT

A method of transporting or shipping at least one item is provided. The method comprises placing the at least one item into a first container. The method further comprises securely closing the first container, locking the first container, placing the first container into a transport container so that the first container fits flush within the transport container, and shipping the containers to a recipient. A security container system for transporting or shipping at least one item is also provided.

### DESCRIPTION OF THE INVENTION

1. Field of the Invention

The present invention relates to a security container system for transporting or shipping items, especially valuable items, and a method for securely transporting or shipping such items and, in particular, to such a system or method that includes a first container that is securely closed and locked, and then placed into a transport container so that a transport company may transport or ship both containers to a recipient.

2. Background of the Invention

Presently, transport or shipping companies such as Federal Express Corporation (“FedEx”), assignee of the present invention, often provide containers in which the transport company or its customers (sometimes referred to herein as “shippers”) place items for transport. These transport containers may include company logos or other indicia on their outside surface. Also, the customer or the transport company may fill out a document that includes information thereon, such as the customer's name and address, and the recipient's name and address, as well as information for billing the costs of the shipment or transport. The document is usually adhered to the outside surface of the container or provided within a clear plastic covering that is adhered to the outside surface. The document or the container may also include a bar code or the like so that the transport container may be tracked by the transport company.

These transport containers are usually made of cardboard materials. Smaller containers, such as for letters, are usually made of a Tyvex® material made by 3M Company. While these containers may comprise a variety of shapes and sizes, these containers usually have square, rectangular, cylindrical, or triangular shapes.

In some instances, items that are valuable are placed within these containers for shipment by a transport company. These items may include, for example, jewelry. In the jewelry industry, consignment sales occur regularly. These types of sales often involve ordering a precious stone or the like from a jewelry wholesaler, who ships the stone to a jewelry dealer. Often, the wholesaler will send many stones, and the dealer and/or the customer of the dealer will decide which, if any, of the stones to purchase. If the dealer or customer decides to purchase one of the stones, the remaining stones may be shipped back to the wholesaler. If the dealer or customer decides not to purchase any of the stones, all of the stones may be shipped back to the wholesaler. This sequence of events may occur several times. In fact, on average, a diamond is shipped eight times before it is purchased by a dealer or customer.

Presently, in some instances, precious jewels or stones are shipped back and forth in gray tub containers. These gray tubs are usually comprised of a transparent plastic material. Also, these gray tubs are usually comprised of such a shape that they are not capable of being placed within the containers sold by the transport companies. Instead, any identifying document(s) are placed directly on the gray tub.

It has been found that the theft of these gray tub containers is a problem. For example, a delivery person of a transport company may be delivering precious stones in a gray tub to a jewelry store located within a shopping mall. The delivery person often has a cart or the like that is filled with packages to be delivered by him or her. Any person passing by the cart may look at the packages on the cart and, if there are any gray tubs located on the cart, may see precious stones located within the gray tub. These tubs and, thus, the stones contained therein, have been stolen from carts.

### SUMMARY OF THE INVENTION

The present invention provides a method of transporting or shipping at least one item. The method includes placing the at least one item into a first container, securely closing the first container, locking the first container, placing the first container into a transport container, wherein the first container fits flush within the transport container, and shipping the containers to a recipient. In one embodiment, the method further comprises, after the containers are shipped to the recipient, opening the transport container, removing the first container from the transport container, unlocking the first container, opening the first container, and removing the at least one item from the first container.

The present invention also provides a security container system for transporting or shipping at least one item. The system includes a first container, which comprises a plurality of walls, with at least one wall being openable with respect to the other walls to open the first container, a secure closing mechanism, and a locking mechanism. The system further includes a transport container. The system also includes at least one item being placed within the first container when the first container is in an opened state; the first container being securely closed, locked; and placed within the transport container so that the first container fits flush within the transport container; and the containers being shipped to a recipient. In one embodiment, the system further includes, after the containers are shipped to the recipient, the transport container being opened, the first container being removed from the transport container, the first container being unlocked and opened, and the at least one item being removed from the first container.

In one embodiment, the first container fits flush within the transport container so that at least one of a length, a width, and a height of the first container is less than about 3/4 inch less than a length, a width, and a height, respectively, of the transport container. The first container may fit flush within the transport container so that at least two of a length, a width, and a height of the first container are both less than about ¾ inch less than a length, a width, and a height, respectively, of the transport container. The first container may fit flush within the transport container so that a length, a width, and a height of the first container are each less than about 3/4 inch less than a length, a width, and a height, respectively, of the transport container.

In another embodiment, the first container fits flush within the transport container so that at least one of a length, a width, and a height of the first container is less than about ½ inch less than a length, a width, and a height, respectively, of the transport container. The first container may fit flush within the transport container so that at least two of a length, a width, and a height of the first container are both less than about ½ inch less than a length, a width, and a height, respectively, of the transport container. The first container may fit flush within the transport container so that a length, a width, and a height of the first container are each less than about ½ inch less than a length, a width, and a height, respectively, of the transport container.

In yet another embodiment, the first container fits flush within the transport container so that at least one of a length, a width, and a height of the first container is less than about 1/4 inch less than a length, a width, and a height, respectively, of the transport container. The first container may fit flush within the transport container so that at least two of a length, a width, and a height of the first container are both less than about ¼inch less than a length, a width, and a height, respectively, of the transport container. The first container may fit flush within the transport container so that a length, a width, and a height of the first container are each less than about 1/4 inch less than a length, a width, and a height, respectively, of the transport container.

The first container is locked by a locking mechanism. The locking mechanism may be at least one of a key lock, a combination lock, a lock openable by a keycard, a Simplex™ lock, a cam lock, a padlock, a servo-lock, or an electromagnetic lock. In one embodiment, the locking mechanism is a combination lock. In another embodiment, the locking mechanism is a key lock.

In one embodiment, the first container is comprised of metal. Optionally, the first container is comprised of aluminum.

The present invention is also directed to a method of preventing theft of at least one item during transport or shipping of the at least one item by a transport company. The method includes shipping the item within a first container that is placed within a transport container. The first container is comprised of metal, and the first container is locked after the item is placed within the first container. Also, the first container fits flush within the transport container for shipment of both containers.

The present invention is also directed to a security container system for preventing theft of at least one item during transport or shipping of the at least one item by a transport company. The system includes a first container comprised of metal. The first container comprises a plurality of walls, where at least one wall is openable with respect to the other walls to open the first container. The first container also includes a secure closing mechanism and a locking mechanism. The system further includes a transport container. In use, the item is placed within the first container, the first container is locked after the item is placed within the first container, the first container is placed within the transport container so that the first container fits flush within the transport container, and the containers are shipped by the transport company.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one embodiment of the invention and together with the description, serve to explain the principles of the invention.

### BRIEF DESCRIPTION OF THE DRAWINGS

FIG. 1 is a perspective view of a first container of the present invention;

FIG. 2 is a top plan view of the first container shown in FIG. 1;

FIG. 3 is a side plan view of the first container shown in FIG. 1;

FIG. 4 is a perspective view of the first container shown in FIG. 1 when in an opened state;

FIG. 5 is a cross-sectional view of the first container taken along the line A-A in FIG. 2;

FIG. 6 is an exploded view of a circled area in FIG. 5 illustrating a secure closing mechanism of the first container;

FIG. 7 is an exploded view of the other circled area in FIG. 5 illustrating a hinge mechanism of the first container;

FIG. 8 is a perspective view of a first container being inserted within a transport container, when the transport container is in an opened state; and

FIG. 9 is a perspective view of the transport container in a closed state, after the first container has been inserted within the transport container.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

The present invention is directed to a method of transporting or shipping at least one item. The present invention is also directed to a security container system for transporting or shipping at least one item. In the most general terms, the present invention includes a first container that is capable of being securely closed and locked, and a transport container, where the first container is capable of being inserted within the transport container for transport or shipping of both containers.

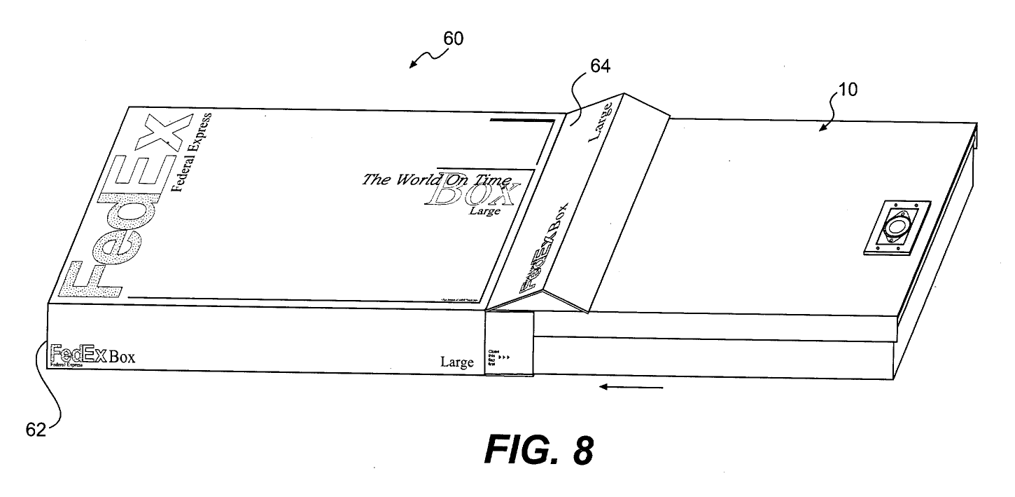

FIG. 8 illustrates a first container 10 and a transport container 60 and, in particular, the first container 10 being inserted within the transport container 60. It should be appreciated that the first and transport containers 10, 60, respectively, of the present invention may comprise a variety of shapes, including, for example, square, rectangular, or cylindrical, or triangular in cross-section. For convenience, the containers 10, 60 as discussed herein are rectangular in shape.

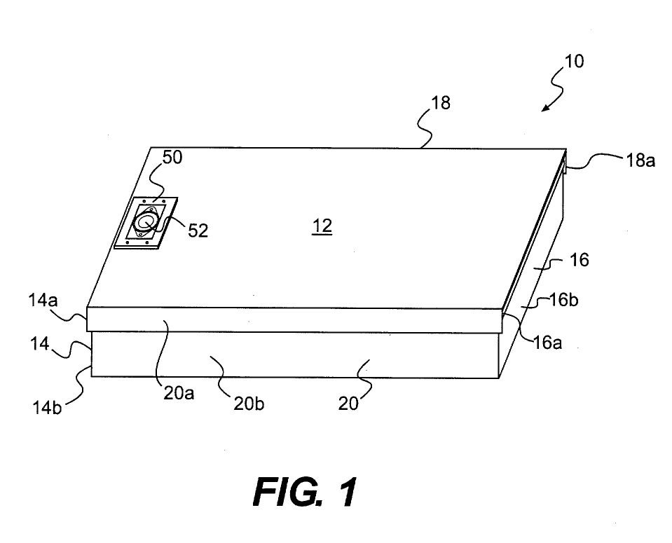

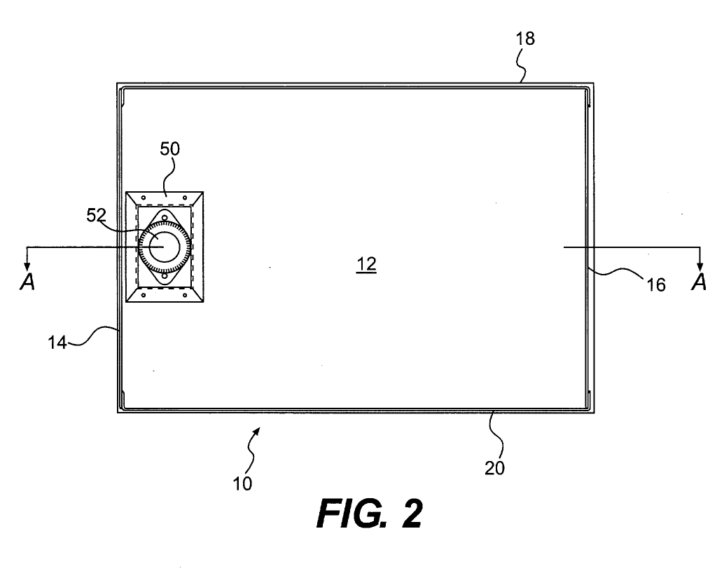

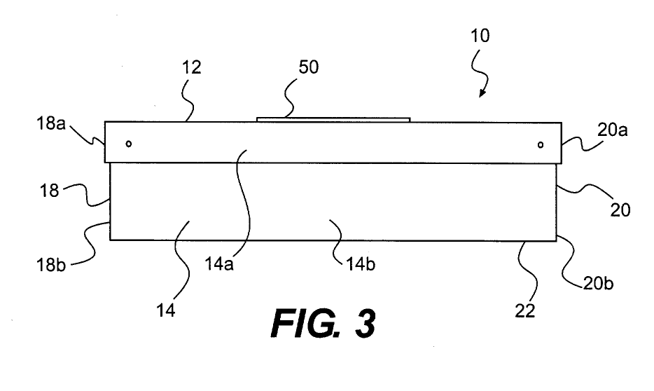

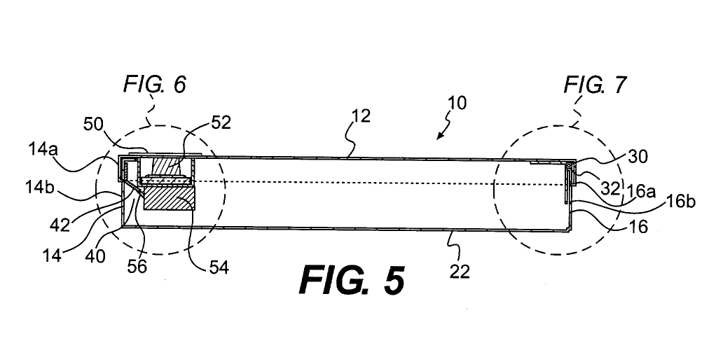

As shown in FIGS. 1-5, the first container 10 includes at least one wall and optionally a plurality of walls. In particular, the first container 10 may comprise a top wall 12, side walls 14, 16, 18, and 20, and a bottom wall 22. In one embodiment, each side wall 14, 16, 18, and 20 comprises an upper portion 14a, 16a, 18a, and 20a, respectively, and a lower portion 14b, 16b, 18b, and 20b, 20a may be connected with the top wall 12, while the lower portions 14b, 16b, 18b, and 20b may be connected with the bottom wall 22. As shown in FIGS. 1 and 3, the upper portions 14a, 16a, 18a, and 20a overlay the lower portions 14b, 16b, 18b, and 20b when the first container 10 is in a closed position.

The first container 10 may be made of a wide variety of suitable materials, such as metal, plastic, or wood, that ensures that the first container 10 is not readily penetrated by a knife or other cutting instrument to gain access to the interior of the first container 10. In one embodiment, the first container 10 is made of aluminum. Also, the first container 10 may comprises a wide variety of sizes. In one embodiment, the first container 10 is provided in two sizes, one being about 11 inches wide, about 13.25 inches long, and about 2.75 inches in height; and the other being about 12.25 inches wide, about 17.625 inches long, and about 2.75 inches in height.

Optionally, the first container 10 is sized to be placed within the transport container 60 so that the first container 10 fits flush within the transport container 60, i.e., arranged so that adjacent sides or walls of the containers 10, 60 are close together. In one embodiment, the first container 10 “fits flush” within the transport container 60 so that there is less than about 3/4 inch distance between an outside of the first container 10 and an inside of the transport container 60 in at least the length, width, or height dimension. In another embodiment, the first container 10 “fits flush” within the transport container 60 so that there is less than about ½ inch distance between the outside of the first container 10 and the inside of the transport container 60 in at least the length, width, or height dimension. In yet another embodiment, the first container 10 “fits flush” within the transport container 60 so that there is less than about 1/4 inch distance between the outside of the first container 10 and the inside of the transport container 60 in at least the length, width, or height dimension.

In one embodiment, the first container fits flush within the transport container so that at least two of a length, a width, and a height of the first container are both less than about ¾, ½, or ¼ inch less than a length, a width, or a height, respectively, of the transport container. In another embodiment, the first container fits flush within the transport container so that a length, a width, and a height of the first container are each less than about ¾, ½, or 1/4 inch less than a length, a width, or a height, respectively, of the transport container.

In one embodiment, the dimensions of the containers 10, 60 may be taken from the outside of both containers, even though it is actually the outside (i.e., the outer surfaces of the walls) of the first container 10 that fit flush relative to the inside (i.e., the inner surfaces of the walls) of the transport container 60. In this embodiment, the thickness of the walls of the transport container 60 is generally small enough to be negligible, for example, about 1/16 inch or less. Then, for the embodiments above, the length, width, or height dimensions of the first container 10 are less than about ¾, ½, or 1/4 inch less than the length, width, or height dimensions, respectively, of the transport container 60.

It should be appreciated that, for the first container 10 to fit flush within the transport container 60, the distances in the length, width, and height dimensions do not all have to be the same ¾, ½, or ¼ inch distance. As one example, the first container 10 may fit flush within the transport container 60 so that there is less than about ¾ inch distance between the outside of the first container 10 and the inside of the transport container 60 in the length dimension, with less than about 1/2 inch distance between the outside of the first container 10 and the inside of the transport container 60 in the width dimension, and with less than about 1/4 inch distance between the outside of the first container 10 and the inside of the transport container 60 in the height dimension. As a second example, the first container 10 may fit flush within the transport container 60 so that there is less than about 1/2 inch distance between the outside of the first container 10 and the inside of the transport container 60 in the length dimension, with less than about 1/2 inch distance between the outside of the first container 10 and the inside of the transport container 60 in the width dimension, and with less than about 1/4 inch distance between the outside of the first container 10 and the inside of the transport container 60 in the height dimension.

It should also be appreciated that the distance between the first container 10 and the transport container 60 in any given dimension may comprise two distances, on two sides of the first container 10. For example, for the length dimension, the distance between the first container 10 and the transport container 60 may comprise both a distance between the wall 14 of the first container 10 (see FIG. 1) and wall 62 of the transport container 60 (see FIG. 8), and a distance between the wall 16 of the first container 10 (see FIG. 1) and wall 64 of the transport container 60 (see FIG. 8) (or if the first container 10 was inserted in the opposite direction, the distance may equal a distance between wall 14 and wall 64, plus a distance between wall 16 and wall 62).

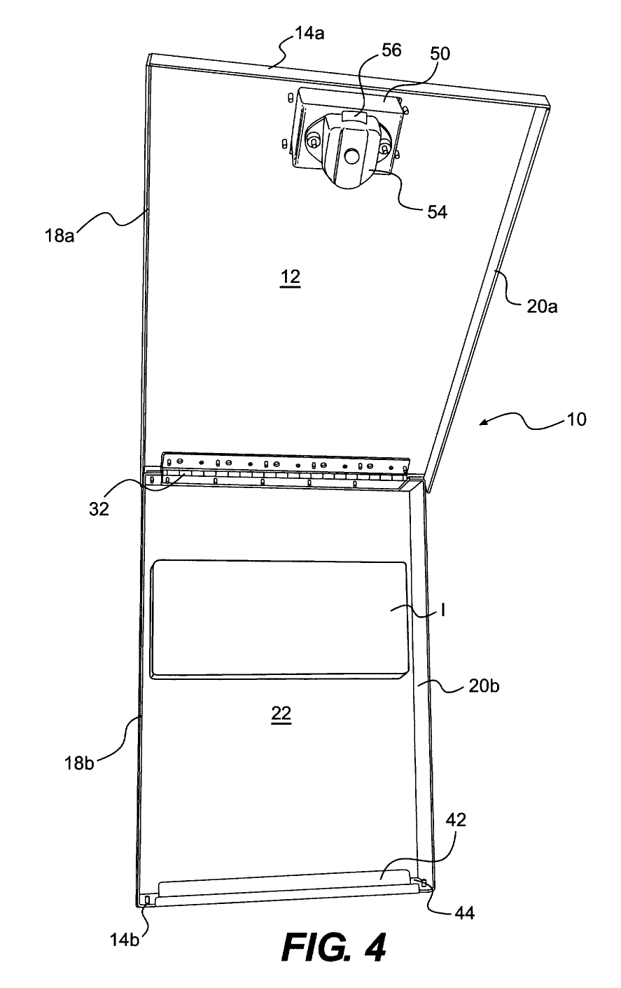

At least one wall of the first container 10 is capable of moving to be openable and closeable relative to one or more of the other walls of the first container 10. In this manner, the first container 10 is capable of being in an opened state (see FIG. 4) and a closed state (see FIG. 1). In the embodiment shown in FIGS. 1-5, the top wall 12, with the upper portions 14a, 16a, 18a, and 20a of the side walls 14, 16, 18, and 20, respectively, are moveable to open and close the first container 10.

Referring to FIGS. 4, 5, and 7, in one embodiment, a hinge mechanism 30 is provided to allow the at least one wall to move relative to the other walls to open and close the first container 10. The hinge mechanism 30 may comprise any type of hinge structure that allows one or more walls to move relative to the one or more of the other walls to open and close the first container 10. Examples of hinge structures include, but are not limited to, continuous or piano hinges, butt hinges (either loose pin or fixed pin), butterfly hinges, flush hinges, barrel hinges, concealed hinges, flat leaf hinges, projection hinges, parliament hinges, strap hinges, T hinges, H hinges, HL hinges, tabletop hinges, spring-loaded hinges, pivot hinges, double-action hinges, knuckle hinges, ball bearing hinges, gravity pilot hinges, offset blind hinges, and back flap hinges. In the embodiment shown, the hinge mechanism 30 comprises a piano hinge 32.

Referring to FIGS. 4-6, in one embodiment, a secure closing mechanism 40 is provided to allow the at least one wall to be secured to the other walls to securely close the first container 10. The secure closing mechanism 40 may comprise any type of secure closing structure that allows one or more walls to be secured to one or more of the other walls to securely close the first container 10. In the embodiment shown, the secure closing mechanism 40 comprises a strike or flange 42 that extends inward from an inner surface 44 of one wall 14 of the first container 10 and an engaging member 56 that extends from a bottom 54 of a locking mechanism 50 (discussed below) toward the flange 42. The engaging member 56 is capable of retracting away from the flange 42 so that the first container 10 may be opened.

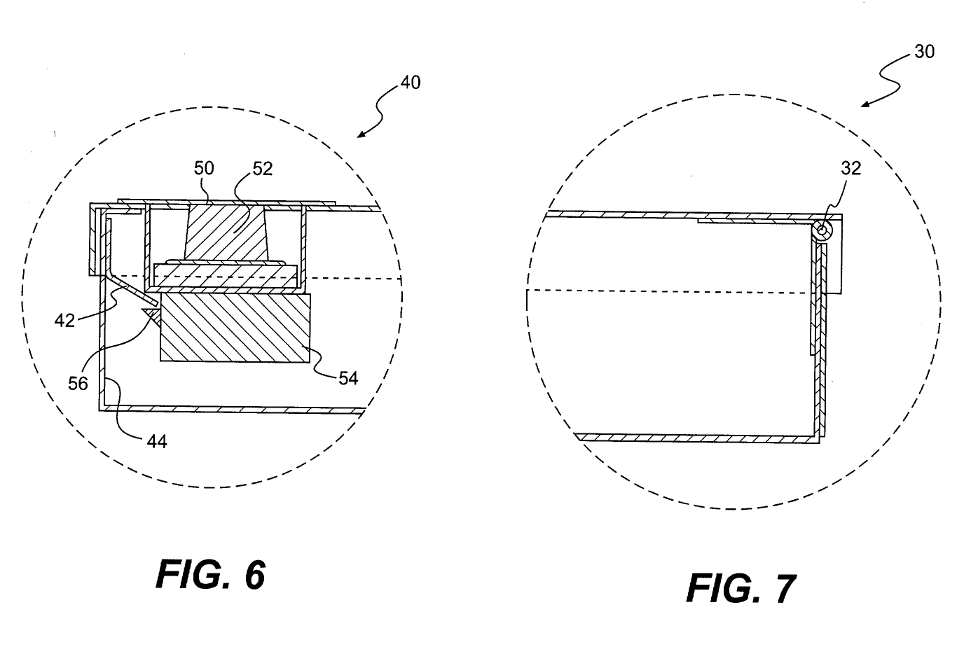

As shown most clearly in FIG. 6, before the locking mechanism 50 is unlocked, the engaging member 56 is not retracted away from the flange 42, but instead extends from the bottom 54 of the locking mechanism 50 toward the flange 42. It should be appreciated that the first container 10 is securely closed by the secure closing mechanism 40 because the engaging member 56 extends outward and beneath the flange 42 so that any movement to open the first container 10 by pulling on a wall, such as by pulling upward on the top wall 12, will cause the engaging member 56 to contact the flange 42 to prevent the first container 10 from being opened.

As shown in FIGS. 1, 2, and 4-6, the locking mechanism 50 is provided to allow the first container 10 to be securely locked. The locking mechanism 50 may comprise any suitable locking mechanism or structure that allows the first container 10 to be securely locked. Examples of locking mechanisms include, but are not limited to, key locks, combination locks, locks openable by a keycard, Simplex™ locks, cam locks, padlocks, servo-locks, and electromagnetic locks (such as sold by Locknetics®, an Ingersoll-Rand business), or the like. In the embodiment shown, the locking mechanism 50 comprises a combination lock 52. In another embodiment, the locking mechanism also comprises the engaging member 56.

In an exemplary embodiment, the locking mechanism 50 comprises Master Lock Model #1654 lock that is sold by Master Lock Co. This lock includes a combination lock 52 and an engaging member 56 comprised of a spring-loaded tongue that extends from the bottom 56 of the locking mechanism 50. In use, once the combination to the combination lock 52 is carried out by rotating or dialing the lock 52, the engaging member 56 is capable of being retracted away from the flange 42 and into the bottom 54 of the locking mechanism 50 so that the first container 10 may be opened. After the combination lock 52 is let go by a user, the engaging member 56 again extends outward toward the flange 42.

In another exemplary embodiment, the locking mechanism 50 comprises Master Lock Model #1823, also known as a Zeypher lock. This is a key lock.

As shown in FIGS. 1-3, 5, and 6, in one embodiment, the locking mechanism 50 may be recessed in the top wall 12. This allows for the top wall 12 to not include any structure that protrudes outward from the top wall 12. This in turn allows for the first container 10 to be easily inserted into the transport container 60.

Because the first container 10 is locked by the locking mechanism 50, the recipient must be able to open the locking mechanism 50. For example, if a combination lock or a Simplex™ lock is utilized, upon receipt of a locked container, the recipient may have to contact the shipper to learn of the combination or code for the combination lock or the Simplex™ lock, respectively. In the alternative, if a lock openable by a key is utilized, the recipient would have to have a key that would open the lock and, thus, the locked first container. The key could be sent or shipped separate from the container to the recipient. In the alternative, both the shipper and the recipient could each have one of a pair of duplicate keys such that the shipper may lock the lock for transport and the recipient may open the lock upon receiving the container.

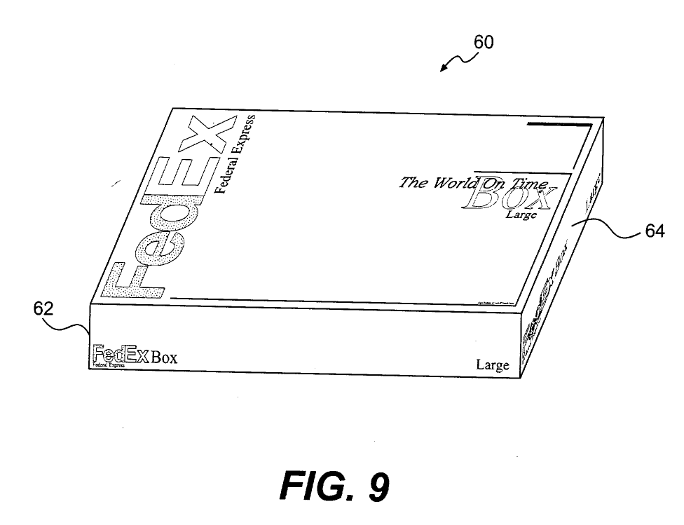

As discussed above, for transport or shipping, the first container 10 is inserted within the transport container 60. The transport container 60 is often sold by a transport company, such as shown in FIGS. 8 and 9. Again, transport containers sold by transport companies may comprise a variety of shapes and sizes. For example, in the square or rectangular shape, FedEx sells a small-, a medium-, and a large-sized rectangular-shaped boxes. The medium-sized box is about 11 ½ inches wide, about 13 ¾ inches long, and about 2 ½ inches in height. The large-sized box is about 12 ½ inches wide, about 18 inches long, and about 3 inches in height.

As shown in FIGS. 8 and 9, in one embodiment, the transport container 60 includes a plurality of walls, including at least two end walls 62, 64. Each end wall 62, 64 may be comprised of a plurality of flaps that are capable of being folded to close each end wall 62, 64. In FIG. 8, the flaps of end wall 62 are not shown because these flaps have been folded so as to close that end wall 62, while flaps of end wall 64 are shown as not being folded so that the transport container 60 is in an opened state. While the transport container 60 is in an opened state, the first container 10 may be inserted within the transport container 60, as shown in FIG. 8. Then after the first container 10 is inserted into the transport container 60, the transport container 60 is closed, such as by folding the flaps of end wall 64. The containers 10, 60 are then ready for shipment or transport, with the first container 10 concealed within the transport container 60, as shown in FIG. 9.

As discussed above, the present invention is also directed to a method of transporting or shipping at least one item. In use, once the first container 10 is opened, as shown in FIG. 4, an item (I) to be shipped to a recipient is placed inside the first container 10. It should be appreciated that more than one item (I) may be placed within the first container 10 for transport or shipping. The one or more items (I) may comprise a wide variety of items, including but not limited to, valuable items, such as jewelry or important papers or documents. The one or more items (I) may be positioned loosely within the first container or within another container before being placed within the first container.

After the one or more items (I) to be transported or shipped are placed within the first container 10, the first container 10 is securely closed and locked. Again, FIG. 1 illustrates the first container 10 is the closed state. As shown in FIG. 8, the first container 10 is then inserted within the transport container 60. As also shown in FIG. 8, in one embodiment, the first container 10 fits flush within the transport container 60. After the first container 10 is inserted within the transport container 60, the transport container 60 is closed, such as by closing the flaps of end walls 62, 64 (see FIGS. 8 and 9). As shown in FIG. 9, the transport company is then capable of shipping the transport container 60, with the first container 10 concealed within the transport container 60, to the recipient.

Because the first container 10 is concealed with the transport container 60, if valuable items are placed within the first container 10, a person seeing the transport container 10 would not realize that valuable items are within the first container 10 because that container 10 is concealed. Instead, the person would only see the transport container 60 and, in one embodiment, a normal, everyday transport container, such as a FedEx box. Also, because the first container 10 is securely closed and locked and, in one embodiment, comprised of a metal such as aluminum, if a person were to cut or penetrate a wall of the transport container 60 to try to gain access to the contents of that container 60, that person would find the first container 10 that is securely closed and locked, and that may be made of material not readily penetrable by a cutting instrument.

Upon receipt of the containers 10, 60, the recipient opens the transport container 60 and removes the first container 10 from the transport container 60. The recipient then unlocks the first container 10. In one embodiment, the recipient must first obtain the means to unlock the first container 10, such as by calling the shipper to learn of the combination or code to the combination lock or the SIMPLEX™ lock, respectively, or by being provided with a key or keycard capable of opening the lock. After unlocking the first container 10, the recipient opens the first container 10. The recipient is then able to retrieve the item(s) (I) that had been placed within the first container 10.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of transporting or shipping at least one item, comprising:
placing the at least one item into a first container;
securely closing the first container;
locking the first container;
placing the first container into a transport container, wherein the first container fits flush within the transport container; and
shipping the containers to a recipient.

2. The method of transporting or shipping at least one item of claim 1, further comprising, after the containers are shipped to the recipient:
opening the transport container;
removing the first container from the transport container;
unlocking the first container;
opening the first container; and
removing the at least one item from the first container.

3. The method of transporting or shipping at least one item of claim 1, wherein the first container fits flush within the transport container so that at least one of a length, a width, and a height of the first container is less than about 3/4 inch less than a length, a width, and a height, respectively, of the transport container.

4. The method of transporting or shipping at least one item of claim 1, wherein the first container fits flush within the transport container so that least two of a length, a width, and a height of the first container are both less than about ¾ inch less than a length, a width, and a height, respectively, of the transport container.

5. The method of transporting or shipping at least one item of claim 1, wherein the first container fits flush within the transport container so that a length, a width, and a height of the first container are each less than about ¾ inch less than a length, a width, and a height, respectively, of the transport container.

6. The method of transporting or shipping at least one item of claim 1, wherein the first container fits flush within the transport container so that at least one of a length, a width, and a height of the first container is less than about 1/2 inch less than a length, a width, and a height, respectively, of the transport container.

7. The method of transporting or shipping at least one item of claim 1, wherein the first container fits flush within the transport container so that at least two of a length, a width, and a height of the first container are both less than about ½ inch less than a length, a width, and a height, respectively, of the transport container.

8. The method of transporting or shipping at least one item of claim 1, wherein the first container fits flush within the transport container so that a length, a width, and a height of the first container are both less than about ½ inch less than a length, a width, and a height, respectively, of the transport container.

9. The method of transporting or shipping at least one item of claim 1, wherein the first container fits flush within the transport container so that at least one of a length, a width, and a height of the first container is less than about ¼ inch less than a length, a width, and a height, respectively, of the transport container.

10. The method of transporting or shipping at least one item of claim 1, wherein the first container fits flush within the transport container so that at least two of a length, a width, and a height of the first container are both less than about ¼ inch less than a length, a width, and a height, respectively, of the transport container.

11. The method of transporting or shipping at least one item of claim 1, wherein the first container fits flush within the transport container so that a length, a width, and a height of the first container are each less than about ¼ inch less than a length, a width, and a height, respectively, of the transport container.

12. The method of transporting or shipping at least one item of claim 1, wherein the first container is locked by a locking mechanism.

13. The method of transporting or shipping at least one item of claim 12, wherein the locking mechanism is at least one of a key lock, a combination lock, a lock openable by a keycard, a Simplex™ lock, a cam lock, a padlock, a servo-lock, or an electromagnetic lock.

14. The method of transporting or shipping at least one item of claim 13, wherein the locking mechanism is a combination lock.

15. The method of transporting or shipping at least one item of claim 13, wherein the locking mechanism is a key lock.

16. The method of transporting or shipping at least one item of claim 1, wherein the first container is comprised of metal.

17. The method of transporting or shipping at least one item of claim 16, wherein the first container is comprised of aluminum.

18. A security container system for transporting or shipping at least one item, comprising:
a first container, wherein the first container comprises a plurality of walls, wherein at least one wall is openable with respect to the other walls to open the first container, a secure closing mechanism, and a locking mechanism; and
a transport container;
wherein the at least one item is placed within the first container when the first container is in an opened state;
wherein the first container is securely closed, and locked;
wherein the first container is placed within the transport container so that the first container fits flush within the transport container; and
wherein the containers are shipped to a recipient.

19. The security container system for transporting or shipping at least one item of claim 18, wherein, after the containers are shipped to the recipient, the transport container is opened, the first container is removed from the transport container, the first container is unlocked and opened, and the at least one item is removed from the first container.

20. The security container system for transporting or shipping at least one item of claim 18, wherein the first container fits flush within the transport container so that at least one of a length, a width, and a height of the first container is less than about 3/4 inch less than a length, a width, and a height, respectively, of the transport container.

21. The security container system for transporting or shipping at least one item of claim 18, wherein the first container fits flush within the transport container so that at least two of a length, a width, and a height of the first container are both less than about 3/4 inch less than a length, a width, and a height, respectively, of the transport container.

22. The security container system for transporting or shipping at least one item of claim 18, wherein the first container fits flush within the transport container so that a length, a width, and a height of the first container are each less than about 3/4 inch less than a length, a width, and a height, respectively, of the transport container.

23. The security container system for transporting or shipping at least one item of claim 18, wherein the first container fits flush within the transport container so that at least one of a length, a width, and a height of the first container is less than about ½ inch less than a length, a width, and a height, respectively, of the transport container.

24. The security container system for transporting or shipping at least one item of claim 18, wherein the first container fits flush within the transport container so that at least two of a length, a width, and a height of the first container are both less than about ½ inch less than a length, a width, and a height, respectively, of the transport container.

25. The security container system for transporting or shipping at least one item of claim 18, wherein the first container fits flush within the transport container so that a length, a width, and a height of the first container are each less than about ½ inch less than a length, a width, and a height, respectively, of the transport container.

26. The security container system for transporting or shipping at least one item of claim 18, wherein the first container fits flush within the transport container so that at least one of a length, a width, and a height of the first container is less than about ¼ inch less than a length, a width, and a height, respectively, of the transport container.

27. The security container system for transporting or shipping at least one item of claim 18, wherein the first container fits flush within the transport container so that at least two of a length, a width, and a height of the first container are both less than about 1/4 inch less than a length, a width, and a height, respectively, of the transport container.

28. The security container system for transporting or shipping at least one item of claim 18, wherein the first container fits flush within the transport container so that a length, a width, and a height of the first container are each less than about 1/4 inch less than a length, a width, and a height, respectively, of the transport container.

29. The security container system for transporting or shipping at least one item of claim 18, wherein the first container is locked by a locking mechanism.

30. The security container system for transporting or shipping at least one item of claim 29, wherein the locking mechanism is at least one of a key lock, a combination lock, a lock openable by a keycard, a Simplex™ lock, a cam lock, a padlock, a servo-lock, or an electromagnetic lock.

31. The security container system for transporting or shipping at least one item of claim 30, wherein the locking mechanism is a combination lock.

32. The security container system for transporting or shipping at least one item of claim 30, wherein the locking mechanism is a key lock.

33. The security container system for transporting or shipping at least one item of claim 18, wherein the first container is comprised of metal.

34. The security container system for transporting or shipping at least one item of claim 33, wherein the first container is comprised of aluminum.

35. A method of preventing theft of at least one item during transport or shipping of the at least one item by a transport company, comprising:
shipping the item within a first container that is placed within a transport container;
wherein the first container is comprised of metal, and wherein the first container is locked after the item is placed within the first container; and
wherein the first container fits flush within the transport container for shipment of both containers.

36. The method of preventing theft of at least one item during transport or shipping of the at least one item by a transport company of claim 35, wherein the first container fits flush within the transport container so that at least one of a length, a width, and a height of the first container is less than about 3/4 inch less than a length, a width, and a height, respectively, of the transport container.

37. The method of preventing theft of at least one item during transport or shipping of the at least one item by a transport company of claim 35, wherein the first container fits flush within the transport container so that least two of a length, a width, and a height of the first container are both less than about 3/4 inch less than a length, a width, and a height, respectively, of the transport container.

38. The method of preventing theft of at least one item during transport or shipping of the at least one item by a transport company of claim 35, wherein the first container fits flush within the transport container so that a length, a width, and a height of the first container are each less than about ¾ inch less than a length, a width, and a height, respectively, of the transport container.

39. The method of preventing theft of at least one item during transport or shipping of the at least one item by a transport company of claim 35, wherein the first container fits flush within the transport container so that at least one of a length, a width, and a height of the first container is less than about ½ inch less than a length, a width, and a height, respectively, of the transport container.

40. The method of preventing theft of at least one item during transport or shipping of the at least one item by a transport company of claim 35, wherein the first container fits flush within the transport container so that at least two of a length, a width, and a height of the first container are both less than about ½ inch less than a length, a width, and a height, respectively, of the transport container.

41. The method of preventing theft of at least one item during transport or shipping of the at least one item by a transport company of claim 35, wherein the first container fits flush within the transport container so that a length, a width, and a FINNEGAN height of the first container are each less than about ½ inch less than a length, a width, and a height, respectively, of the transport container.

42. The method of preventing theft of at least one item during transport or shipping of the at least one item by a transport company of claim 35, wherein the first container fits flush within the transport container so that at least one of a length, a width, and a height of the first container is less than about 1/4 inch less than a length, a width, and a height, respectively, of the transport container.

43. The method of preventing theft of at least one item during transport or shipping of the at least one item by a transport company of claim 35, wherein the first container fits flush within the transport container so that at least two of a length, a width, and a height of the first container are both less than about ¼ inch less than a length, a width, and a height, respectively, of the transport container.

44. The method of preventing theft of at least one item during transport or shipping of the at least one item by a transport company of claim 35, wherein the first container fits flush within the transport container so that a length, a width, and a height of the first container are each less than about ¼ inch less than a length, a width, and a height, respectively, of the transport container.

45. The method of preventing theft of at least one item during transport or shipping of the at least one item by a transport company of claim 35, wherein the first container is locked by a locking mechanism.

46. The method of preventing theft of at least one item during transport or shipping of the at least one item by a transport company of claim 35, wherein the locking mechanism is at least one of a key lock, a combination lock, a lock openable by a keycard, a Simplex™ lock, a cam lock, a padlock, a servo-lock, or an electromagnetic lock.

47. The method of preventing theft of at least one item during transport or shipping of the at least one item by a transport company of claim 35, wherein the first container is comprised of aluminum.

48. A security container system for preventing theft of at least one item during transport or shipping of the at least one item by a transport company, comprising:
a first container comprised of metal, wherein the first container comprises a plurality of walls, wherein at least one wall is openable with respect to the other walls to open the first container, a secure closing mechanism, and a locking mechanism;
a transport container;
wherein the item is placed within the first container;
wherein the first container is locked after the item is placed within the first container;
wherein the first container is placed within the transport container so that the first container fits flush within the transport container; and
wherein the containers are shipped by the transport company.

49. The security container system for preventing theft of at least one item during transport or shipping of the at least one item by a transport company of claim 48, wherein the first container fits flush within the transport container so that at least one of a length, a width, and a height of the first container is less than about ¾ inch less than a length, a width, and a height, respectively, of the transport container.

50. The security container system for preventing theft of at least one item during transport or shipping of the at least one item by a transport company of claim 48, wherein the first container fits flush within the transport container so that at least two of a length, a width, and a height of the first container are both less than about 3/4 inch less than a length, a width, and a height, respectively, of the transport container.

51. The security container system for preventing theft of at least one item during transport or shipping of the at least one item by a transport company of claim 48, wherein the first container fits flush within the transport container so that a length, a width, and a height of the first container are each less than about 3/4 inch less than a length, a width, and a height, respectively, of the transport container.

52. The security container system for preventing theft of at least one item during transport or shipping of the at least one item by a transport company of claim 48, wherein the first container fits flush within the transport container so that at least one of a length, a width, and a height of the first container is less than about 1/2 inch less than a length, a width, and a height, respectively, of the transport container.

53. The security container system for preventing theft of at least one item during transport or shipping of the at least one item by a transport company of claim 48, wherein the first container fits flush within the transport container so that at least two of a length, a width, and a height of the first container are both less than about 1/2 inch less than a length, a width, and a height, respectively, of the transport container.

54. The security container system for preventing theft of at least one item during transport or shipping of the at least one item by a transport company of claim 48, wherein the first container fits flush within the transport container so that a length, a width, and a height of the first container are each less than about ½ inch less than a length, a width, and a height, respectively, of the transport container.

55. The security container system for preventing theft of at least one item during transport or shipping of the at least one item by a transport company of claim 48, wherein the first container fits flush within the transport container so that at least one of a length, a width, and a height of the first container is less than about 1/4 inch less than a length, a width, and a height, respectively, of the transport container.

56. The security container system for preventing theft of at least one item during transport or shipping of the at least one item by a transport company of claim 48, wherein the first container fits flush within the transport container so that at least two of a length, a width, and a height of the first container are both less than about 1/4 inch less than a length, a width, and a height, respectively, of the transport container.

57. The security container system for preventing theft of at least one item during transport or shipping of the at least one item by a transport company of claim 48, wherein the first container fits flush within the transport container so that a length, a width, and a height of the first container are each less than about 1/4 inch less than a length, a width, and a height, respectively, of the transport container.

58. The security container system for preventing theft of at least one item during transport or shipping of the at least one item by a transport company of claim 48, wherein the first container is locked by a locking mechanism.

59. The security container system for preventing theft of at least one item during transport or shipping of the at least one item by a transport company of claim 58, wherein the locking mechanism is at least one of a key lock, a combination lock, a lock openable by a keycard, a Simplex™ lock, a cam lock, a padlock, a servo-lock, or an electromagnetic lock.

60. The security container system for preventing theft of at least one item during transport or shipping of the at least one item by a transport company of claim 48, wherein the first container is comprised of aluminum.
